(19) United States
(12) Patent Application Publication
(10) Pub. No.: US 2005/0204034 A1
(43) Pub. Date: Sep. 15, 2005

(54) Methods, systems, and products for monitoring multiple tasks to fulfill a request originating from a web browser

(76) Inventor: Sandeep R. Betarbet, Lilburn, GA (US)

Correspondence Address: Scott P. Zimmerman, P.O. Box 3822, Cary, NC, 27519, US

(21) Appl. No.: 10/799,847

(22) Filed: Mar. 12, 2004

(51) Int. Cl. G06F 15/173

(52) U.S. Cl. 709/224; 709/205

(57) ABSTRACT

Methods, systems, and products are disclosed for monitoring multiple tasks to fuilfill a request originating from a web browser. One method communicates a progress page to the web browser. The progress page includes progress messages for each of the multiple tasks. The progress page also includes an Embedded Refresh Component that forces the web browser to periodically again request the progress page. When the multiple tasks are completed, a final progress page is communicated to the web browser, and the final progress page eliminates the Embedded Refresh Component.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to computer processing and, more particularly, to monitoring the status of computer processes.

2. Description of the Related Art

A web browser often triggers a single task. When a user makes a submission from a web browser, that submission often triggers the execution of a single background task to fulfill the submission. When the user makes the submission, the submission is forwarded to a server. The server executes the task, and then the server sends a response. This response, in the simplest scenario, is a requested web page—that is, the user submitted a request for the web page, and the server retrieves the web page and returns it to the user. A slightly more complicated scenario is when the user requests a search. Here the user submitted a request for a search, and the server searches for the requested information. The server will usually respond with the requested search results. The server, however, may encounter an error, and the server responds with an error message. Either scenario, however, required a single background task to fulfill the requested submission.

A web browser, however, may also trigger multiple background tasks. The user makes the submission from the web browser, yet this submission involves more than a single background task. Here the submission triggers many other tasks, and some or all of these tasks must be completed before the server may send a response. The multiple tasks may require seconds, or even many minutes, to execute. While the tasks are executing, however, the user is not informed of the progress. No dynamic message is returned to the web browser informing the user of the progress made in executing the multiple tasks. The user who submitted the request is not capable of monitoring the concurrent or serial tasks which are in progress. Because the user is not informed of the progress, many users grow impatient, stop the transaction, and make another request. Sometimes the session expires and the web browser will not respond to any communication/response from the server. There is, accordingly, a need in the art for methods and systems of monitoring the progress of multiple tasks to fulfill a request from a web browser. These methods and systems should periodically inform the user of the progress of the various tasks that have been triggered by the submission through the web browser. These methods and systems would then tell the user whether the tasks are proceeding in the right order, whether the tasks are performing as expected, and whether any failure/exception has occurred.

### BRIEF SUMMARY OF THE INVENTION

The aforementioned problems, and other problems, are reduced by this invention. This invention comprises methods, computer systems, computer programs, and computer program products that monitor the progress of multiple tasks. These multiple tasks are triggered to fulfill a request from a web browser. Before the request can be fulfilled, these multiple tasks must be completed. This invention allows a user of the web browser to monitor the progress of the multiple tasks. This invention concurrently triggers a thread for each task. As each task is executed, this invention periodically collects progress messages for each task. A progress page is then dynamically created with the task progress messages and any other static and dynamic (e.g. environmental, resource utilization) information. These progress messages describe how the execution of each task is progressing.

Communication via HTTP is accomplished via a request and response mechanism. A request or response is a packet of information composed of headers (which contain control data) and a body (which contains the data to be rendered). Typically the browser behaves as the client or the requestor of information and the application server is its provider. The headers determine how the body (of the request or response) is interpreted. A header has a name and attributes (or a value in the case of a single attribute). The headers used for control in the invention include REFRESH, STATUS and LOCATION.

Upon a request for a task update from a web browser, a uniquely named progress page is created. A response is also created with the STATUS header set to 302 (REDIRECT) and the LOCATION header set to the Progress Page Uniform Resource Locator (PP-URL) is returned to the web browser. The REDIRECT status in the response directs the web browser to immediately request the uniquely named (and newly created) progress page at the PP-URL. The progress page (returned in the response to the request) includes an embedded refresh component. The Embedded Refresh Component (“ERC”) is represented as a REFRESH header. The REFRESH header represents a response header but is contained within the progress page. The REFRESH header has two (2) attributes including URL and CONTENT. The URL attribute is set to the Task Monitor Uniform Resource Locator (“TM-URL”) and the CONTENT attribute is set to a time period. This header directs the web browser to unilaterally make a request for a status update at the TM-URL at the end of the time period after the progress page has been fully loaded by the web browser. Upon receiving the request, the invention erases the previously retrieved progress page and creates a new progress page by compiling all of the current progress messages from each task. Upon completion of creation of the new progress page, a REDIRECT response with the LOCATION set to the PP-URL (of the latest progress page) is returned to the web browser. This response directs the web browser (as before) to immediately request the new progress page (located by the PP-URL). The progress page is in turn returned to the web browser, and (as before) the progress page includes an Embedded Refresh Component (ERC). The Embedded Refresh Component (ERC) again directs the browser to request a task update (at the TM-URL) after the specified time period. In response to this request, a new progress page is created and the REDIRECT response is returned to the browser. This results in the web browser immediately making a request for the new progress page, which is then communicated to the web browser. This updated progress page includes updated progress messages describing how the execution of each task is currently progressing. This updated progress page, however, again includes the Embedded Refresh Component (ERC). The web browser is thus periodically directed to request an updated progress page. When, however, all of the tasks are completed, a final progress page is communicated to the web browser. This final progress page describes the final disposition of all the tasks. This final progress page, however, does not include an Embedded Refresh Component (ERC), so the web browser is not directed to request any more progress pages.

This invention discloses methods, systems, and products for monitoring multiple tasks in a client-server environment. One of the embodiments describes a method for monitoring the status of multiple tasks to fulfill a request originating from a web browser. This method communicates a progress page to the web browser. The progress page includes progress messages for each of the multiple tasks. The progress page also includes an Embedded Refresh Component (ERC) that directs the web browser to request the status of the tasks after a specified time period. This results in the retrieval of the progress page by the Web Browser. When the multiple tasks are completed, a final progress page is communicated to the web browser, and the final progress page eliminates the Embedded Refresh Component (ERC).

Another of the embodiments describes another method for monitoring multiple tasks. These multiple tasks fulfill a request originating from a web browser. Here progress messages are read, and the progress messages correspond to a task object in a task list. A template for a progress page is read, a refresh time period is read, and the Task Monitor Uniform Resource Locator (TM-URL) is read. A progress page is created by merging the progress messages, the template (for presenting an HTML formatted reply) and an Embedded Refresh Component (ERC). The Embedded Refresh Component (ERC) is represented by a REFRESH header with the CONTENT attribute (set to the refresh time period) and the URL attribute (set to the TM-URL). In response to a request for an updated status from the browser, a REDIRECT response with the LOCATION header set to the PP-URL and the STATUS set to 302 is returned. This response forces the Browser to immediately request the progress page located at the PP-URL. The progress page includes the Embedded Refresh Component (ERC). The Embedded Refresh Component (ERC) includes a time period and the Task Monitor Uniform Resource Locator (TM-URL). The Embedded Refresh Component (ERC) directs the web browser to request the status of the tasks at the TM-URL upon completion of the specified time period. The Task Monitor (in response to such a browser request) creates a progress page and returns a REDIRECT response to force the Browser to request the newly created progress page (at the PP-URL). When the multiple tasks are completed, a final progress page is communicated to the web browser, and the final progress page eliminates the Embedded Refresh Component (ERC).

Other embodiments of this invention describe a system for monitoring multiple tasks. The system comprises a Request Process Module stored in a memory device and a processor communicating with the memory device. The Request Process Module communicates a first progress page to a web browser upon initiation of the specified tasks. This is done by initiating the tasks, creating a progress page and redirecting the browser to obtain the progress page. The progress page comprises progress messages for each of the multiple tasks to fulfill a request originating from the web browser. The progress page includes an Embedded Refresh Component (ERC) that forces the web browser to again request the status of the tasks. When the multiple tasks are completed, the Task Monitor communicates a final progress page to the web browser, and the final progress page eliminates the embedded refresh component.

Other embodiments of this invention describe a computer program product. A computer-readable medium stores a Request Process Module. The Request Process Module communicates a progress page to a web browser (via the REDIRECT response mechanism) after initiating all the tasks that need to be monitored. The progress page comprises progress messages for each of multiple tasks to fulfill a request originating from the web browser. The progress page includes an Embedded Refresh Component (ERC) that forces the web browser to again request the status of the tasks from the Task Monitor. This in turn results in the creation of a progress page and the return of a REDIRECT response. The REDIRECT response forces the browser to immediately retrieve the progress page. When the multiple tasks are completed, the Task Monitor communicates a final progress page to the web browser. This final progress page eliminates the Embedded Refresh Component (ERC).

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

These and other features, aspects, and advantages of the embodiments of the present invention are better understood when the following Detailed Description of the Invention is read with reference to the accompanying drawings, wherein:

FIGS. 1 and 2 are simplified schematics illustrating one or more embodiments of this invention;

FIG. 3 depicts possible operating environments for one or more embodiments of this invention;

FIG. 4 is a flowchart illustrating a method of monitoring the progress of the multiple tasks, according to the embodiments of this invention;

FIG. 5 is a flowchart illustrating another method of monitoring the progress of the multiple tasks, according to more embodiments of this invention; and

FIG. 6 is a flowchart illustrating still another method of monitoring the progress of the multiple tasks, according to even more embodiments of this invention.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

This invention monitors the progress of multiple tasks. These multiple tasks are triggered to fulfill a request from a web browser. Before a final response can be communicated to the web browser, these multiple tasks must be completed. This invention allows a user of the web browser to monitor the progress of the multiple tasks. This invention concurrently triggers a thread for each task. Upon receiving a task trigger request at a Request Process Module, this invention triggers the tasks, collects the initial progress messages for each task and creates a Progress Page and its Progress Page Uniform Resource Locator (PP-URL). These progress messages describe how the execution of each task is progressing. A response is then returned to the web browser. This response is a REDIRECT response with the STATUS header set to 302 and the LOCATION header set to the Progress Page Uniform Resource Locator (PP-URL). The REDIRECT response forces the browser to immediately request a progress page located at the PP-URL. This progress page is composed of all the progress messages from each task. The progress page is subsequently returned to the web browser. The progress page includes an Embedded Refresh Component (ERC). The Embedded Refresh Component is composed of a Task Monitor Uniform Resource Locator (TM-URL) and a time period. This Embedded Refresh Component (ERC) forces the browser to make a request for a task status update at the TM-URL after the specified time period. This is a request for a status update of the tasks being executed (which were earlier initiated by the browser). A Task Monitor, upon receiving such a request, compiles the progress messages from all the tasks and creates a progress page and a Progress Page Uniform Resource Locator (PP-URL). The Task Monitor then returns a REDIRECT response with the STATUS header set to 302 and LOCATION header set to the PP-URL (i.e. to the newly created progress page) back to the browser. This response forces the browser to immediately request the progress page at the specified PP-URL. When the updated progress page is returned, the updated progress page includes the updated progress messages describing how the execution of each task is currently progressing. This updated progress page, however, again includes an Embedded Refresh Component (ERC). The ERC is composed of the Task Monitor Uniform Resource Locator (TM-URL) and a time interval. After loading the progress page, the web browser waits for the specified time interval and then requests a task status update at the TM-URL. The web browser is thus forced to periodically request a task status update. When, however, all of the tasks are completed, a final progress page is communicated to the web browser. This final progress page describes the final disposition of all the tasks. This final progress page, however, does not include an Embedded Refresh Component (ERC), so the web browser is not forced to request a task status update.

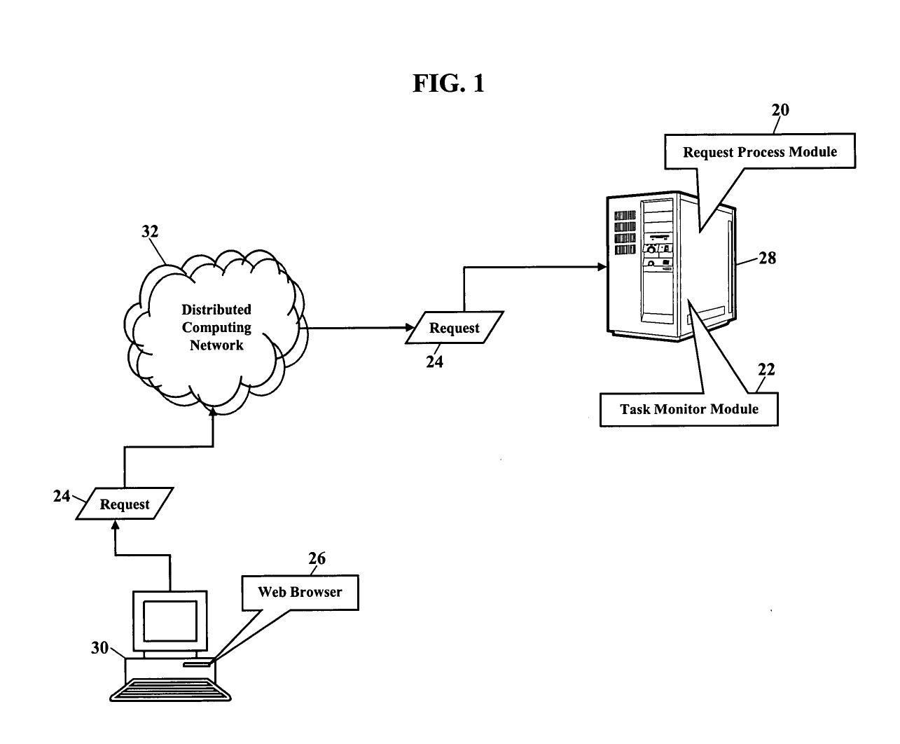

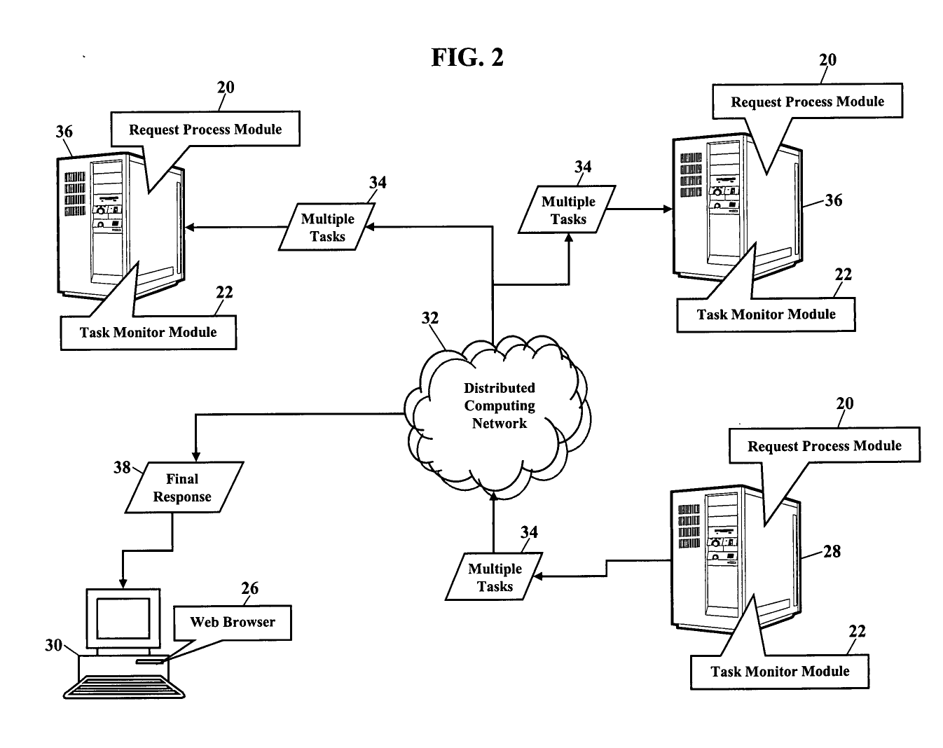

FIGS. 1 and 2 are simplified schematics illustrating this invention. The embodiments of this invention include a Request Process Module 20 and/or a Task Monitor Module 22. The Request Process Module 20 and the Task Monitor Module 22 each comprise methods, systems, computer programs, and/or computer program products that monitor the progress of multiple tasks to fulfill a request 24 originating from a web browser 26. The Request Process Module 20 and the Task Monitor Module 22 operate within any computer system, such as an application server 36. The web browser 26 also operates within any computer system, such as a client computer 30. As those of ordinary skill in the art of computing understand, the web browser 26 is a computer program that offers a user access to a distributed computing network 32, such as the Internet (sometimes alternatively known as the “World Wide Web”), an intranet, a local-area network (LAN), and/or a wide-area network (WAN). The web browser 26 commonly provides a graphical user interface that lets the user access icons and menu options to view and to navigate web pages. While NETSCAPE® and Microsoft's Internet Explorer are currently popular versions of the web browser 26, this invention is compatible with any version and/or any developer's web browser. (NETSCAPE® is a registered trademark of Netscape Communications Corporation, P.O. Box 7050, Mountain View, Calif. 94039-7050, (650) 254-1900, http://channels.netscape.com/ns/info/defaultjsp, while MICROSOFT® and the Internet Explorer logo are registered trademarks of Microsoft Corporation, One Microsoft Way, Redmond Wash. 98052-6399, 425.882.8080, www.microsoft.com).

The request 24 triggers multiple tasks. The request 24 originates from the web browser 26 operating within the client computer 30. The request 24 communicates from the client computer 30 to the one or more web servers 28 via the distributed computing network 32. As FIG. 2 shows, the web server 28 may then delegate multiple tasks 34 to one or more application 36. That is, to fulfill the request 24 from the web browser 26, some or all of the multiple tasks 34 must be accomplished before a final response 38 can be return communicated to the web browser 26. The one or more application servers 36 perform the multiple tasks 34 and then return communicates the final response 38. The final response 38 communicates to the client computer 30 via the distributed computing network 32.

This invention allows the user at the client computer 30 to monitor the progress of the multiple tasks 34. The Request Process Module 20 and the Task Monitor Module 22, in other words, provide a mechanism for monitoring the multiple tasks 34 triggered to fulfill the request 24 from the web browser 26. The user typically does not receive the final response 38 until the one or more application servers 36 have either completed, or failed, the multiple tasks 34. If the multiple tasks 34 are of a short duration, the user may not desire to monitor the progress. If, however, the multiple tasks 34 are of an indefinite/dynamic duration, the user often grows frustrated, abandons the original request 24, and makes a second, redundant request.

This invention, however, monitors the progress of the multiple tasks 34. The Request Process Module 20 and the Task Monitor Module 22 monitor the multiple tasks 34. The Request Process Module 20 and/or the Task Monitor Module 22 may periodically update the user on the progress of the multiple tasks 34. The user at the client computer 30, for example, may be updated every five (5) seconds, ten (10) seconds, every minute, or whatever interval the user desires. This invention may also inform the user how far each task has progressed, thus letting the user decide whether the multiple tasks 34 are proceeding in the right order, whether the multiple tasks 34 are performing as expected, and whether any individual task has failed. This invention may also inform the user of any unusual events, or any messages, that each individual task wants to convey to the web browser 26.

The web server 28 and the application server 36 are familiar components of the distributed computing network 32. As those of ordinary skill in the art of computing understand, the application server 36 processes one or more of the multiple tasks 34 and returns a dynamic response to the web browser 26. As those of ordinary skill in the art of computing also understand, the web server 28 delivers cached content to the web browser 26. The web server 28 serves web pages to the client computer 30 via the distributed computing network 32. The web server 28 stores/hosts web pages, scripts, programs, and/or multimedia files and serves them using any protocol, such as Hyper-Text Transfer Protocol (HTTP). The web server 28 may be dedicated or non-dedicated. If the web server 28 is dedicated, its sole purpose is to store/host web content. If, however, the web server 28 is non-dedicated, it can be used for basic computing in addition to storing/hosting web content.

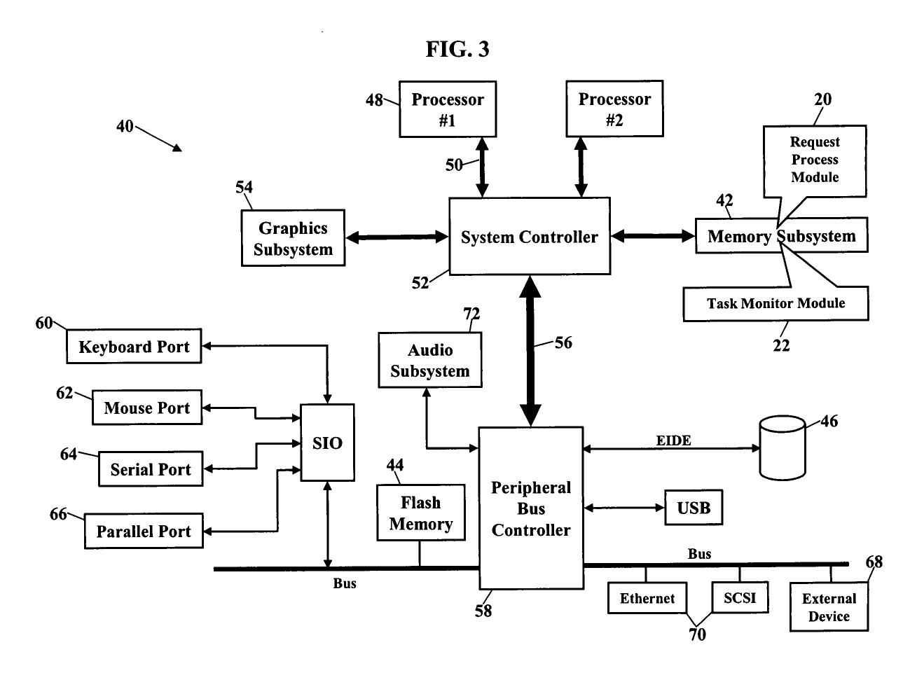

FIG. 3 depicts another possible operating environment for the embodiments of this invention. FIG. 3 is a block diagram showing the Request Process Module 20 and the Task Monitor Module 22 residing in a computer system 40. The computer system 40 may be any computing system, such as the web server 28, the client computer 30, the application server 36, or any other computer device. As FIG. 3 shows, the Request Process Module 20 and the Task Monitor Module 22 operate within a system memory device. The Request Process Module 20 and the Task Monitor Module 22, for example, are shown residing in a memory subsystem 42. The Request Process Module 20 and the Task Monitor Module 22, however, could also reside in flash memory 44 or a peripheral storage device 46. The computer system 40 also has one or more central processors 48 executing an operating system. The operating system, as is well known, has a set of instructions that control the internal functions of the computer system 40. A system bus 50 communicates signals, such as data signals, control signals, and address signals, between the central processor 48 and a system controller 52 (typically called a “Northbridge”). The system controller 52 provides a bridging function between the one or more central processors 48, a graphics subsystem 54, the memory subsystem 42, and a PCI (Peripheral Controller Interface) bus 56. The PCI bus 56 is controlled by a Peripheral Bus Controller 58. The Peripheral Bus Controller 58 (typically called a “Southbridge”) is an integrated circuit that serves as an input/output hub for various peripheral ports. These peripheral ports are shown including a keyboard port 60, a mouse port 62, a serial port 64 and/or a parallel port 66 for a video display unit, one or more external device ports 68, and networking ports 70 (such as SCSI or Ethernet). The Peripheral Bus Controller 58 also includes an audio subsystem 72. Those of ordinary skill in the art understand that the program, processes, methods, and systems described in this patent are not limited to any particular computer system or computer hardware.

Those of ordinary skill in the art also understand the central processor 48 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The preferred operating system is the UNIX® operating system (UNIX® is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT° is a registered trademark of Red Hat, Inc., Research Triangle Park, N.C., 1-888-733-4281, www.redhat.com). Other operating systems, however, are also suitable. Such other operating systems would include a WINDOWS-based operating system (WINDOWS® is a registered trademark of Microsoft Corporation, One Microsoft Way, Redmond Wash. 98052-6399, 425.882.8080, www.Microsoft.com). and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The system memory device (shown as memory subsystem 42, flash memory 44, or peripheral storage device 46) may also contain an application program. The application program cooperates with the operating system and with a video display unit (via the serial port 64 and/or the parallel port 66) to provide a Graphical User Interface (GUlI). The Graphical User Interface typically includes a combination of signals communicated along the keyboard port 60 and the mouse port 62. The Graphical User Interface provides a convenient visual and/or audible interface with a user of the computer system 40.

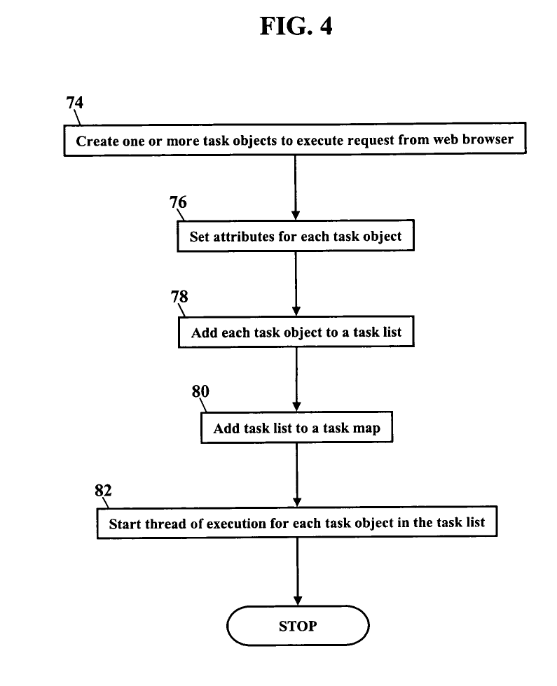

FIG. 4 is a flowchart illustrating a method of monitoring the progress of the multiple tasks (shown as reference numeral 34 in FIG. 2). This method is performed by the Request Process Module, although the Task Monitor Module may additionally or alternatively perform this method (the Request Process Module and the Task Monitor Module are shown, respectfully, as reference numerals 20 and 22 in FIGS. 1-3). The Request Process Module creates one or more task objects (Block 74) to execute the request from the web browser (the request and the web browser are shown, respectfully, as reference numerals 24 and 26 in FIGS. 1 and 2). As those of ordinary skill in the art understand, each task object contains attributes which the independent thread of execution uses as parameters for actions. These attributes are set before the thread of execution is started. A “progress message” is an example of an attribute for each task object. A progress message may be either a text message and/or a binary message. The progress message, corresponding to each task object, is updated by its thread of execution. As the following paragraphs explain, the Request Process Module and/or the Task Monitor Module then use these progress messages to monitor the progress of the multiple tasks.

After the task object(s) is/are created (Block 74), the attributes for each task object are set (Block 76). Each task object is added to a task list (Block 78). The task list is a listing of all the task objects and represents all the tasks to be executed in response to the original web browser request. The task list is then added to a task map (Block 80). The task map is a tabular/logical map with (name, value) pairs. The task map, in this case, matches the task list to a corresponding session identification. The session uniquely identifies requests from a host accessing the Request Process Module. The session identification is thus the key for each (name, value) pair in the task map. The task map is a global/static object for the application. The thread of execution is then started for each task object in the task list (Block 82).

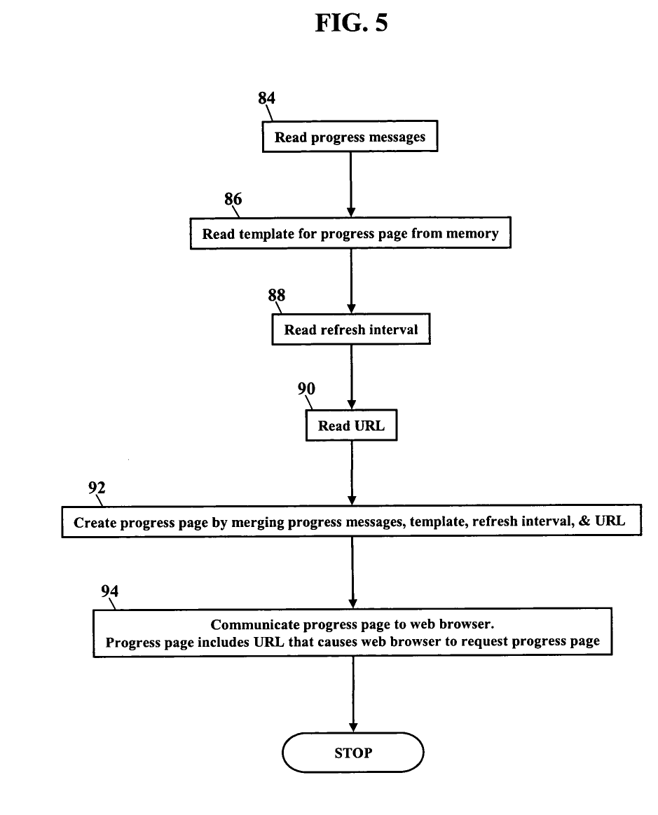

FIG. 5 is a flowchart illustrating another method of monitoring the progress of the multiple tasks (shown as reference numeral 34 in FIG. 2). This method is executed by both the Request Process Module and the Task Monitor Module (the Request Process Module and the Task Monitor Module are shown, respectfully, as reference numerals 20 and 22 in FIGS. 1-3). In the preferred embodiment the Request Process Module executes this method once, and the Task Monitor Module periodically executes this method until the multiple tasks are completed. Those of ordinary skill in the art, however, will recognize that this method may be performed in other combinations.

As FIG. 5 shows, the progress messages are read (Block 84). Each progress message corresponds to a task object in the task list. A template for a progress page is read from memory (Block 86). The template is a pattern or skeleton for reporting the progress messages. The template is typically a JSP/HTML page, yet the template may be any format that is presentable on the web browser. After the template is read, a refresh time period is read (Block 88) and a Task Monitor Uniform Resource Locator (TM-URL) is read/created (Block 90). A progress page is then created (Block 92). The progress page is created by merging the progress messages, the template, the Embedded Refresh Component (composed of the refresh time period, and the Task Monitor Uniform Resource Locator (TM-URL)). The progress page is a file which is dynamically generated by inserting the progress message(s) into the template. Each progress page preferably has a unique filename at creation. A REDIRECT response is returned to the web browser. The REDIRECT response consists of a STATUS heading set to 302 and a LOCATION header set to the Progress Page Uniform Resource Locator (PP-URL). The web browser upon receiving the REDIRECT response immediately makes a request at the PP-URL for the progress page. In response, the progress page is communicated to the web browser (Block 94). The progress page contains an Embedded Refresh Component (ERC). The Embedded Refresh Component (ERC) is represented a REFRESH header with attributes URL (set to the Task Monitor Uniform Resource Locator (TM-URL)) and CONTENT (set to a time period). This header tag causes the web browser to request an update to the status of the tasks by invoking the TM-URL after the specified time interval.

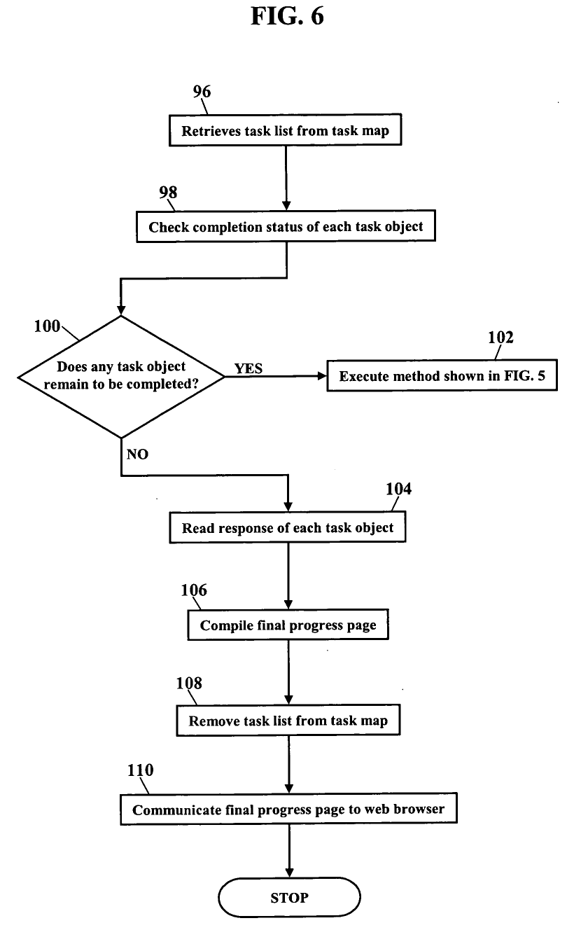

FIG. 6 is a flowchart illustrating still another method of monitoring the progress of the multiple tasks (shown as reference numeral 34 in FIG. 2). This method is preferably executed by the Task Monitor Module (shown as reference numeral 22 in FIGS. 1-3). Those of ordinary skill in the art, however, will recognize that this method may additionally or alternatively be performed by the Request Process Module (shown as reference numeral 20 in FIGS. 1-3). The Task Monitor Module retrieves the task list from the task map (Block 96). The completion status of each task object is then checked (Block 98). If any task object remains to be completed (Block 100), the Task Monitor Module executes the method shown in FIG. 5 (Block 102). If, however, all the task objects are completed (Block 100), then the Task Monitor Module reads the response of each task object (Block 104). A final progress page is compiled (Block 106) and the task list is removed from the task map (Block 108). The multiple tasks are thus completed, and the final progress page is communicated to the web browser (Block 110). The final progress page eliminates the Embedded Refresh Component.

As those of ordinary skill now recognize, each successive progress report is dynamically created. Each progress report may contain more content than a simple text message. The progress report, for example, may contain pictures, icons, and other graphic content. The progress report may also contain hyperlinks to other content. Each successive progress report may even utilize a different template, thus having a different “look and feel.” Because each successive progress report is dynamically created, an administrator can have freedom to select the “look and feel” for each progress report. The user at the client computer may even specify the content of the progress report, thus individualizing the “look and feel” of a user interface. Because all the elements of the progress report are dynamically populated, including the progress messages, any images, and/or any text, the progress report can include informative system/performance/personal content. If an unforeseen event occurs (such as a diagnostic message from another server, or perhaps a system failure message), the messages describing this unforeseen event can be included in the progress report. The progress report may even include personal content, such as weather conditions, sports scores, or any other desired content. Each progress report thus provides the user, viewing the web browser at the client computer, a wide variety of system performance messages/data and personal messages/data.

The Request Process Module and the Task Monitor Module may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the Request Process Module and the Task Monitor Module to be easily disseminated. A computer program product for monitoring multiple tasks includes the Request Process Module and/or the Task Monitor Module stored on the computer-readable medium. The Request Process Module and/or the Task Monitor Module communicates the progress page to the web browser. The progress page comprises progress messages for each of multiple tasks to fulfill a request originating from the web browser. The progress page includes an embedded tag (ERC) that forces the web browser to again request the progress page. When the multiple tasks are completed, the Request Process Module and/or the Task Monitor Module communicates a final progress page to the web browser, and the final progress page eliminates the embedded tag (ERC).

The Request Process Module and/or the Task Monitor Module may also be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

1. A method of monitoring multiple tasks to fulfill a request originating from a web browser, the method comprising the steps of:
communicating a progress page to the web browser, the progress page comprising progress messages for each of the multiple tasks, the progress page including an Embedded Refresh Component that forces the web browser to again request the progress page; and
when the multiple tasks are completed, communicating a final progress page to the web browser, the final progress page eliminating the Embedded Refresh Component.

2. A method according to claim 1, further comprising the step of dynamically generating the progress page by inserting the progress messages into a template.

3. A method according to claim 1, further comprising the step of communicating a communication to the web browser, the communication forcing the web browser to initially request the progress page.

4. A method according to claim 1, wherein the step of communicating the progress page to the web browser further comprises including a refresh interval with the Embedded Refresh Component, the refresh interval causing the web browser to again request the progress page.

5. A method according to claim 1, wherein the step of communicating the progress page to the web browser further comprises including a Uniform Resource Locator with the Embedded Refresh Component, the Uniform Resource Locator corresponding to the progress page.

6. A method of monitoring multiple tasks to fulfill a request originating from a web browser, the method comprising the steps of:
reading progress messages corresponding to a task object in a task list;
reading a template for a progress page;
reading a refresh interval;
reading a Uniform Resource Locator;
creating a progress page by merging the progress messages, the template, the refresh interval, and the Uniform Resource Locator;
communicating the progress page to the web browser, the progress page including the Uniform Resource Locator that causes the web browser to again request the progress page; and
when the multiple tasks are completed, communicating a final progress page to the web browser, the final progress page eliminating the Uniform Resource Locator.

7. A method according to claim 6, further comprising the step of communicating a communication to the web browser, the communication causing the web browser to initially request the progress page.

8. A method according to claim 6, further comprising the step of communicating a communication to the web browser, the communication including a second Uniform Resource Locator that that causes the web browser to initially request the progress page.

9. A method according to claim 6, further comprising the step of creating a task object corresponding to each task.

10. A method according to claim 9, further comprising the step of adding each task object to a task list.

11. A method according to claim 10, further comprising the step of adding the task list to a task map, the task map matching the task list to a session identification.

12. A method according to claim 6, further comprising the step of retrieving a task list from a task map.

13. A method according to claim 6, further comprising the step of checking a completion status of all task objects.

14. A method according to claim 13, wherein if all the task objects are completed, then removing a task list from a task map.

15. A system, comprising:
a Request Process Module stored in a memory device, the Request Process Module communicating a progress page to a web browser, the progress page comprising progress messages for each of multiple tasks to fulfill a request originating from the web browser, the progress page including an Embedded Refresh Component that forces the web browser to again request the progress page, and when the multiple tasks are completed, the Request Process Module communicates a final progress page to the web browser, and the final progress page eliminates the Embedded Refresh Component; and
a processor communicating with the memory device.

16. A computer program product, comprising:
a computer-readable medium; and
a Request Process Module stored on the computer-readable medium, the Request Process Module communicating a progress page to a web browser, the progress page comprising progress messages for each of multiple tasks to fulfill a request originating from the web browser, the progress page including an Embedded Refresh Component that forces the web browser to again request the progress page, and when the multiple tasks are completed, the Request Process Module communicates a final progress page to the web browser, and the final progress page eliminating the Embedded Refresh Component.
